(19) United States
(12) Patent Application Publication
(10) Pub. No.: US 2025/0241221 A1
(43) Pub. Date: Jul. 31, 2025

(54) COUPLING DEVICE

(71) Applicant: Tru-Turf Pty Ltd, Robina (AU)

(72) Inventors: Scott BULLARD, Whistler (CA); Stephen PEACOCK, Brisbane (AU)

(21) Appl. No.: 19/041,596

(22) Filed: Jan. 30, 2025

Related U.S. Application Data
(63) Continuation-in-part of application No. 29/954,983, filed on Jul. 30, 2024.

(30) Foreign Application Priority Data
Jan. 30, 2024 (AU) 2024900211

(51) Int. Cl. A01B 59/042; B60D 1/06; B60D 1/145; B60D 1/52; B60D 1/66

(52) U.S. Cl. CPC A01B 59/042; B60D 1/06; B60D 1/145; B60D 1/52; B60D 1/66

(57) ABSTRACT

A coupling device configured to connect an equipment to a towing vehicle, wherein the coupling device comprises: a connecting part configured to releasably connect to the equipment; a stabiliser configured to assist in holding the coupling device in an alignment position prior to releasable connection with the equipment; and a connector piece configured to releasably connect to a corresponding connector on the towing vehicle.

### CROSS-REFERENCE TO RELATED APPLICATION(S)

The present application claims priority to Australian provisional patent application no. 2024900211 filed on 30 Jan. 2024, and U.S. design patent application Ser. No. 29/954,983 filed on 30 Jul. 2024, the contents of each of which are incorporated herein in their entirety for all purposes.

### TECHNICAL FIELD

The present disclosure relates generally to coupling device. In particular, the present disclosure relates, but is not limited, to a coupling device that is configured to connect equipment, in the form of a turf roller, to a towing vehicle. The present disclosure also relates to a method of coupling equipment to a towing vehicle.

### BACKGROUND OF INVENTION

Ride-on turf rollers, such as the type used on golf greens and fine turf surfaces on golf courses and sporting fields, generally have a plurality of rollers that press against and flatten the ground as the turf roller is in motion. These turf rollers are powered by a motor, and may have a seat for a user and at least one control, such as a control stick, steering wheel, foot pedal, switches, etc, to control the motion of the roller. The user conventionally sits facing perpendicularly to the direction of motion of the roller. When not in use, turf rollers are often transported between different locations, such as a storage location or other locations where turf is to be rolled.

Ride-on turf rollers may have wheels which engage the ground when the rollers of the machine are not used such that the rollers are lifted away from the ground when the wheels are being used. Ride-on turf rollers may be placed onto a trailer to be towed by a vehicle. Otherwise, they may have an integrated connecting part which attaches to a hitch on a towing vehicle. The integrated connecting part may be fixed in position in some instances. There also exist ride-on turf rollers which have a folding connecting part assembly. When the roller is in use, the folding connecting part may be folded up and away from the ground. When the roller is not in use, the folding connecting part may be folded downwards to a position where it can be attached to a vehicle for towing. These folding connecting parts are manually moveable by a user between the in-use towing position and standby position. The folding connecting part may be indirectly connected to the wheels or axle(s) such that moving the connecting part into the in-use towing position also causes the wheels to engage the ground and the rollers to be lifted away from the ground. Similarly, folding the connecting part into the standby position will lift the wheels from the ground so that the rollers of the turf roller engage the ground.

A number of compromises exist with current towing devices for ride-on turf rollers of the above type. For example, when a folding connecting part is moved to a standby position, it may partially obstruct the view of a user of the roller. The folding connecting part cannot generally be removed from the turf roller and this adds additional weight when the roller is in use. Furthermore, it may require a larger amount of effort for a user to manually move connecting parts and wheels into an in-use position for towing.

Bearing this in mind, the present inventor(s) have developed an improved coupling device.

Any reference to or discussion of any document, act or item of knowledge in this specification is included solely for the purpose of providing a context for the present invention. It is not suggested or represented that any of these matters or any combination thereof formed at the priority date part of the common general knowledge, or was known to be relevant to an attempt to solve any problem with which this specification is concerned.

### SUMMARY OF INVENTION

According to the present disclosure there is provided a coupling device configured to connect an equipment to a towing vehicle, wherein the coupling device comprises: a connecting part configured to releasably connect to the equipment; and a connector piece configured to releasably connect to a corresponding connector on the towing vehicle.

There is further provided a coupling device configured to connect an equipment to a towing vehicle, wherein the coupling device comprises: a connecting part configured to releasably connect to the equipment; a stabiliser configured to assist in holding the coupling device in an alignment position prior to releasable connection with the equipment; and a connector piece configured to releasably connect to a corresponding connector on the towing vehicle.

According to embodiments, the equipment is a turf roller, preferably a ride-on turf roller.

According to embodiments, the equipment comprises an attachment portion to which the connecting part may be releasably connected. The attachment portion may comprise a receiver.

According to embodiments, one of the connecting part and the attachment portion comprises a receiver and the other comprises an engaging member. According to embodiments, the coupling part comprises the engaging member and the attachment portion comprises the receiver. According to other embodiments, the coupling part comprises the receiver and the attachment portion comprises the engaging member.

According to embodiments, the receiver comprises an opening and the engaging member is configured for insertion into the receiver.

According to embodiments, a termination of the engaging member includes at least one wall tapering towards a central axis of the engaging member. The at least one wall may form a spike. The at least one wall may form part of a tapering projection. The spike may provide a pointed end of the termination. The engaging member may form at least part of a shaft.

According to embodiments, the receiver comprises a tapered funnel. The tapered funnel may be configured to assist in locating the engaging member for insertion into the receiver. The funnel may be provided at an opening of the receiver. The funnel may provide the opening of the receiver. The funnel may form at least a part of the opening of the receiver. The funnel may be configured to locate the termination of the engaging member therein. The tapered funnel may comprise at least one angled wall. The at least one angled wall of the funnel may be oriented at substantially a similar orientation to and orientation of the at least one tapering wall of the engaging member.

The connecting part and the attachment portion may be aligned relative to one another in a locking position or alignment position. According to embodiments, the connecting part and attachment portion are in a locking position or an alignment position when the engaging member is inserted a predetermined distance into the receiver.

According to embodiments, the engaging member comprises at least one protrusion. The at least one protrusion may be configured to engage with a surface of the receiver when the connecting part and the attachment portion are in the locking position or alignment position. According to embodiments, the tapered funnel comprises the surface of the receiver. According to embodiments, the at least one protrusion includes an angled surface that is configured to engage with the surface of the tapered funnel.

According to embodiments, the coupling device comprises a locking pin. The locking pin may be configured to releasably lock the connecting part and the attachment portion in the locking position. According to embodiments, the locking pin is received through holes in at least one of the connecting part and attachment portion. The engaging member and/or the receiver may comprise the holes. According to embodiments, the locking pin is spring loaded and/or is configured to automatically engage with the hole(s).

According to embodiments, the corresponding connector on the vehicle is a tow bar, tow hitch or tow ball.

According to embodiments, the connector piece is a coupler configured to receive a tow bar, tow hitch or tow ball. According to embodiments, the coupler includes a size adjustable portion. The size adjustment portion may be configured such that the coupler may receive different tow bar, tow hitch or tow ball sizes. The size adjustable portion may include at least one insert. According to embodiments, the connector piece comprises a receiving area configured to receive the corresponding connector of the towing vehicle.

According to embodiments, the coupling device comprises an adjustment structure such that a position of the connector piece on the connecting part can be adjusted to suit towing vehicles having the corresponding connector at different heights above the ground. The adjustment structure may comprise a pair of plates which are fastenable to each other in a plurality of relative positions.

According to embodiments, coupling device comprises a stabiliser. The stabiliser may comprise at least one leg. The stabiliser and/or leg may be sized to hold the connecting part a predetermined distance above the ground such that the connecting part and attachment portion are substantially in alignment prior to and during their connection.

According to embodiments, the stabiliser comprises a kick stand. According to embodiments, the stabiliser comprises a jockey wheel. According to embodiments, the leg is height adjustable.

According to embodiments, the stabiliser comprises a clamping mechanism. The clamping mechanism may be moveable between a clamped orientation and an unclamped orientation. The clamping mechanism may be configured to releasably clamp the coupling device to a tow bar of the towing vehicle. The clamping mechanism may comprise a lever. The lever may comprise a user engageable portion and/or a hand grip. The clamping mechanism may comprise a jaw. The jaw may comprise at least one pad. The pad may be configured to engage with a surface of a tow bar. The clamping mechanism may be pivotable relative to a body of the coupling device. The clamping mechanism may be pivotable relative to the connector piece.

The coupling device may comprise a pivot part. The pivot part may be connected to the connector piece. The pivot part may form part of the connector piece. The clamping mechanism may pivot relative to the pivot part. The jaw and/or lever may pivot relative to the pivot part. The coupling device may comprise at least one shaft or pivot about which the clamping mechanism may pivot. The jaw and/or lever may pivot about the shaft or pivot. The shaft may be attached directly or indirectly to the pivot part. The clamping mechanism may move in a linear direction to releasably clamp to a tow bar.

The clamping mechanism may be releasably lockable in the clamped orientation. Locking the clamping mechanism in the clamped orientation may enable the coupling device to be retained substantially rigidly in a clamped position on the tow bar. The clamping mechanism may be releasably locked or retained relative to the connector piece. The lever may be releasably retained relative to the connector piece via a locking means or retaining mechanism. The locking means or retaining mechanism may comprise at least one retaining portion with at least one hole through which a retaining member may pass. The retaining portion may be a retaining plate. The retaining member may be a pin. The pin may be inserted and removed by a user. The lever may be retained in a clamped orientation when the pin is inserted in the at least one hole of the retaining plate.

According to embodiments, the coupling device may be configured such that the equipment may be moved towards the coupling device to couple the connecting part to the equipment. According to embodiments, the equipment is a turf roller and the turf roller is driven on its rollers towards the coupling device to couple the connecting part to the equipment.

According to embodiments, the connector piece and the connecting part are located at opposed ends of the coupling device.

According to embodiments, the coupling device comprises at least one handle proximal to the connector piece.

According to embodiments, the coupling device comprises at least one handle. The at least one handle may be located substantially in a central position on the coupling device. The at least one handle may be positioned proximal to the stabiliser

Another aspect of the present disclosure provides an equipment configured to connect to the connecting part of the coupling device of any of the aspects and/or embodiments described herein.

Another aspect of the present disclosure provides an equipment comprising a turf roller configured to connect to the connecting part of the coupling device of any of the aspects and/or embodiments described herein.

According to embodiments, the equipment comprises receiver with an opening to receive an engaging member of the connecting part of the coupling device.

According to embodiments, the receiver comprises an opening and a tapered funnel at the opening.

According to embodiments, the equipment and/or turf roller comprises: at least one wheel; and at least one mechanism for moving each wheel towards or away from the ground.

According to embodiments, the at least one mechanism, comprises an actuator, is motor driven and/or is a hydraulic mechanism. When the mechanism is motor driven, the motor may be an electric or mechanical motor.

According to embodiments, each wheel comprises a respective mechanism.

There is further provided herein according to an aspect, a coupling system comprising: a coupling device of any aspect and/or embodiment provided herein; and an attachment portion configured to be attached to an equipment, and configured to connect to the connecting part.

According to embodiments, the coupling system comprises the equipment. The equipment may comprise the attachment portion.

According to embodiments, the coupling system further comprises a connector stand. According to embodiments, the connector stand comprises a stand connector configured to connect to the connector piece of the coupling device.

According to embodiments, the coupling system further comprises a coupling pin or locking pin to releasably lock the connecting part in a locking orientation with the attachment portion.

According to embodiments, the equipment is a turf roller.

According to a further aspect there is provided a method of coupling an equipment to a towing vehicle, wherein the method comprises: a) providing a coupling device, the coupling device having a connecting part and a connector piece, the coupling device may be as substantially described herein in relation to any aspect and/or embodiment; b) providing an equipment; c) providing a towing vehicle having a corresponding connector; d) connecting the connecting part of the coupling device to the equipment and releasably locking the coupling device to the equipment; and e) coupling the connector piece of the coupling device to the corresponding connector of the towing vehicle. Steps d) and e) may be performed in any order.

According to embodiments, step e) includes utilising a clamping mechanism of the coupling device to clamp the coupling device to a towing bar of the towing vehicle. Step e) may be performed before step d). The clamping mechanism may be unclamped from the towing bar when the connecting part of the coupling device has been connected to the equipment and/or when the coupling device is releasably locked to the equipment.

Another aspect of the present disclosure provides a method for coupling an equipment to a coupling device, comprising: providing a coupling device, the coupling device having a connecting part; positioning the coupling device such that the connecting part is at a first height above a ground; providing an equipment, the equipment having an attachment portion, wherein the attachment portion and connecting part are configured to engage with one another; and engaging the attachment portion with the connecting part.

According to embodiments, the step of engaging the attachment portion with the connecting part includes moving the equipment or the connecting part relative to each other until the attachment portion engages with the connecting part.

According to embodiments, the step of engaging the attachment portion with the connecting part includes moving the equipment towards the connecting part until the attachment portion engages with the connecting part.

According to embodiments, the coupling device of the method may be substantially as described in any aspect and/or embodiment and/or example herein.

According to embodiments, the equipment is a turf roller comprising a plurality of rollers. Moving the equipment towards the connecting part may comprise driving the turf roller on its rollers.

According to embodiments, the coupling device comprises a stabiliser which positions the connecting part at the first height such that the connecting part and attachment portion are substantially in alignment prior to and during engagement of the connecting part with the attachment portion.

According to embodiments, the coupling device comprises a connector piece and the method further comprises coupling the connector piece to a towing vehicle. The stabiliser may comprise a clamping mechanism which clamps the coupling device to a tow bar of the towing vehicle to hold the connecting part at the first height above the ground. The clamping mechanism may be substantially as described herein in any aspect, embodiment or example.

According to embodiments, the stabiliser comprises a leg sized to hold the connecting part at the first height above the ground.

According to embodiments, the attachment portion is positioned on the equipment at substantially the first height above the ground.

According to embodiments, one of the connector part and attachment portion comprises a receiver, and the other of the connector part and attachment portion comprises a member configured to be at least partially located within the receiver when the attachment portion engages with the connecting part.

According to embodiments, the method further comprises locking the coupling device to the equipment when the attachment portion is engaged with the connecting part. According to embodiments, locking the coupling device to the equipment comprises fastening the attachment portion to the connecting part.

According to embodiments, the equipment comprises at least one wheel. According to embodiments, the wheel is moved to a lowered position where it may engage the ground. This may occur after the attachment portion engages with the connecting part. The at least one wheel may be moved to the lowered position and/or to a raised position using at least one mechanism. According to embodiments, when the wheel is in the lowered position, the engaged attachment portion and connecting part are lifted to a second height above the ground which is higher than the first height.

According to embodiments, the coupling device comprises a connector piece and the method further comprises coupling the connector piece to a towing vehicle.

According to embodiments, the connector piece engages with a tow bar, tow hitch and/or tow bar on the towing vehicle.

Further aspects and/or embodiments of the present disclosure of possible beyond those described in the above summary. Some such aspects and embodiments may be clear from the description that follows and from the attached figures. The present disclosure should be understood as including all such aspects and embodiments or any combination of features thereof.

### BRIEF DESCRIPTION OF DRAWINGS

Embodiments of the invention will now be described with reference to the accompanying drawings. It is to be understood that the embodiments are given by way of illustration only and the invention is not limited by this illustration. In the drawings:

FIG. 1 shows an isometric view of a coupling device according to the present disclosure;

FIG. 2 shows an isometric view of a connector piece and plate of the coupling device of FIG. 1;

FIG. 3 shows the connector piece of FIG. 2 without the plate;

FIG. 4 shows an isometric view of an insert for the connector piece of FIG. 3;

FIG. 5 shows an isometric view of the coupling device of FIG. 1 with the connector piece of FIG. 2 removed;

FIG. 6 is an isometric view of the coupling device of FIG. 1 coupled to part of a turf roller;

FIG. 7 is an isometric view of part of the turf roller shown in FIG. 6;

FIG. 8 is an isometric view of the underside of the part of the turf roller shown in FIGS. 6 and 7;

FIG. 9 is a side view of part of the turf roller shown in FIGS. 6 to 8;

FIG. 10 is an isometric view of the underside of a frame of the turf roller shown in FIGS. 6 to 9;

FIG. 11 is an isometric view of a connector stand;

FIGS. 12 to 14 are isometric views of a coupling device, connector stand and turf roller in different respective orientations;

FIG. 15 is an isometric view of a height adjustable leg for a coupling device;

FIGS. 16 and 17 are isometric views of a coupling device having a stabiliser in the form of a clamping mechanism in a clamped configuration;

FIGS. 18 and 19 are isometric views of the coupling device in FIGS. 16 and 17 where the clamping mechanism is in an unclamped configuration; and

FIGS. 20 to 23 are either isometric or side views of the coupling device, shown in FIGS. 16 to 19, aligning or engaging with a turf roller whilst the coupling device may be in an uncoupled or coupled configuration.

### DETAILED DESCRIPTION

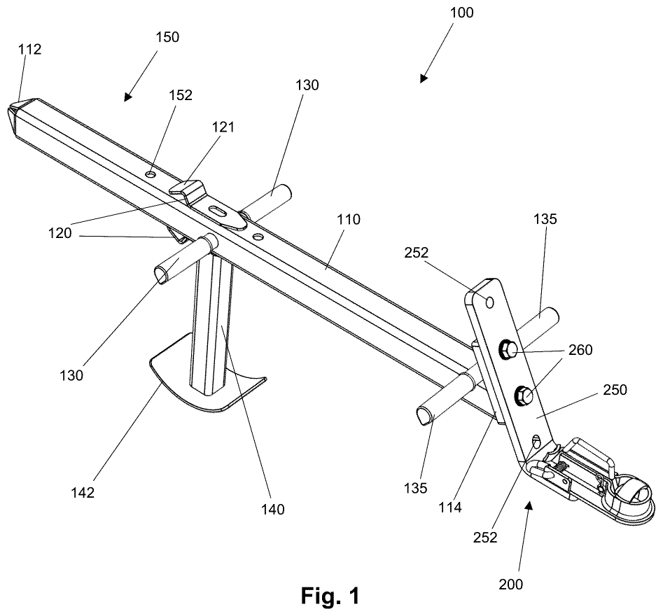

A coupling device according to the present disclosure may take many forms, of which FIG. 1 depicts an example. A coupling device within the scope of the present disclosure may include any one of more features of the device shown in FIG. 1 or equivalent to those shown, provided the coupling device performs a desired coupling function. For example, the coupling device may be utilised to couple an equipment, such as a turf roller, to a towing vehicle or otherwise to a connector stand. The coupling device may act as an intermediary tool to connect the equipment to the towing vehicle or connector stand.

The coupling device 100 shown in FIG. 1 is a substantially elongate device. The coupling device 100 may comprise a body. The coupling device 100 may comprise an elongate bar 110 of substantially rigid material. The elongate bar 110 may form part of the body of the coupling device 100. The elongate bar 110 may have a substantially hollow interior. The elongate bar 110 may be in the form of a drawbar and/or may function as a drawbar. The elongate bar 110 may be formed at least partly from a metal or metal alloy. According to other possible embodiments, the coupling device comprises a structure shaped other than elongate. The elongate bar 110 may be replaced with some other body portion of the coupling device 100, for example.

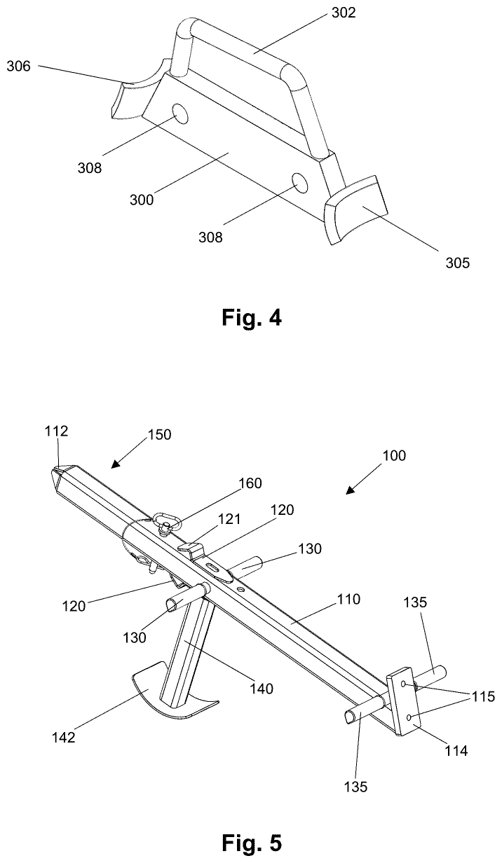

The coupling device 100 comprises a connecting part 150. The connecting part 150 may be at least a portion of the elongate bar 110. As shown in FIG. 1, the connecting part 150 is an end of the coupling device 100. In this regard, the connecting part 150 may be an end of the elongate bar 110 in this embodiment. In other possible embodiments, the connecting device 100 forms a body of the coupling device 100 or a part of a body of the coupling device 100. The connecting part 150 may be connected to a body of the coupling device 100. The connecting part 150 may be connected to the body of the coupling device 100 at the first end. The connecting part 150 may be attached to the elongate bar 110. The connecting part 150 may be formed from a metal or metal alloy. The coupling device 100 may comprise a first end and a second end. The first end may be configured for coupling to an equipment. The equipment to which the first end may be coupled may be a turf roller 800. The first end may comprise the connecting part 150. The second end may be configured for coupling to a towing vehicle (not shown). In the example shown, the second end comprises a connector piece 200. The connector piece 200 may be configured to releasably connect to a corresponding connector on a towing vehicle. The connector piece used on the coupling device may differ to the connector piece shown in the Figures. It is understood that any type or configuration of a connector piece may be utilised with the coupling device of the present disclosure. The disclosure is not limited to the features of the coupling device depicted, for example, in FIGS. 3 and 4 which are provided by way of example.

The first end of the coupling device 100 comprises an engaging member. The engaging member includes one or more walls tapering towards a central axis of the connecting part 150. The one or more walls form a spike 112. The spike 112 may form a termination of the connecting part 150. Other embodiments are possible where the first end and/or termination of the connecting part 150 does not comprise a spike 112. For example, the first end may include a receptacle for receiving part of the equipment.

The connecting part 150 may connect to an attachment portion. The equipment may comprise the attachment portion. The attachment portion may comprise a receiver 400. In the embodiment shown in the Figures, the termination of the connecting part 150 is configured for insertion into an opening of a receiver 400 on the equipment. The spike 112 and/or tapering walls of the first end of the coupling device 100 may be utilised as a locator. This may provide scope for misalignment between the opening of the receiver 400 and the termination of the connecting part 150 when the connecting part 150 is being inserted.

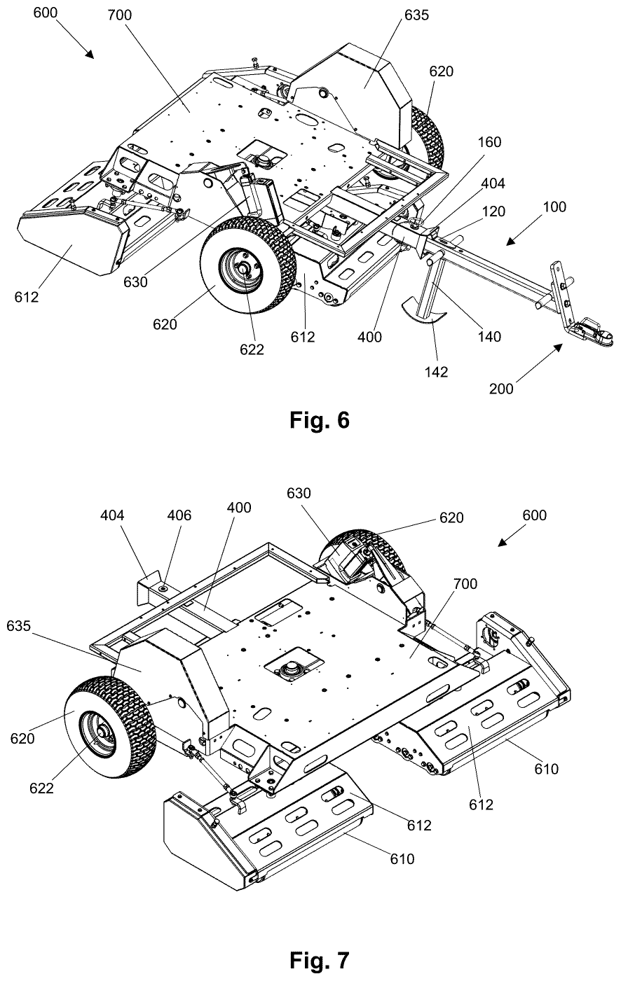

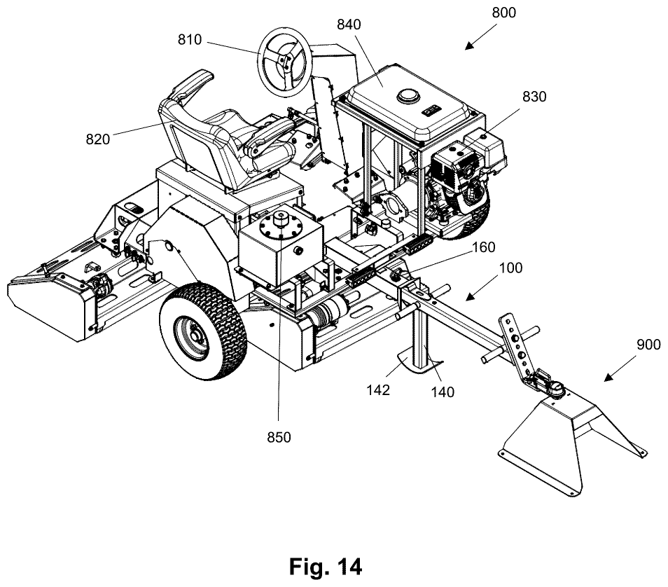

The connecting part 150 may be configured for insertion into the receiver 400 by a predetermined amount until it is in a locking position. For example, FIGS. 6 and 14 show the connecting part 150 and receiver 400 in a locking position. In the locking position, the connecting part 150 may be inserted into the receiver 400 by at least 10 cm, at least 20 cm, at least 30 cm, at least 40 cm, at least 50 cm, at least 60 cm, at least 70 cm, more than 80 cm, about 50 cm, about 40 cm, about 60 cm, up to about 1 metre, up to about 1.5 metres, between about 10 cm and about 1.5 metre, between about 20 cm and about 1.5 metre, between about 30 cm and about 1.2 metre, between about 40 cm and about 1.2 metre, between about 50 cm and about 1 metre, between about 40 cm and about 90 cm or any desired amount around or within these ranges. The connecting part 150 is preferably inserted into the receiver 400 by a predetermined distance to its locking position in order to provide a strong and/or sturdy connection between the connecting part 150 and the receiver 400.

The coupling device 100 may comprise at least one protrusion 120. The at least one protrusion 120 may extend outwardly from the coupling device 100. The connecting part 150 may comprise the at least one protrusion 120. The at least one protrusion 120 may be on an outer surface of the connecting part 150. The at least one protrusion 120 may extend outwardly from the connecting part 150. The at least one protrusion 120 may be on the outer surface of the elongate bar 110. In the embodiment shown in FIG. 1, there are two protrusions 120 on the outer surface of the connecting part 150. One protrusion 120 is located on a top surface of the connecting part 150, and another protrusion 120 is located on a lower surface of the connecting part 150. The protrusion(s) 120 may be formed integrally with the connecting part 150. The protrusion(s) 120 may be formed integrally with the elongate bar 110. The protrusion(s) 120 may be formed from at least one separate piece and attached to the connecting part 150. In the example shown, the protrusions 120 are separate pieces of material, such as metal or metal alloy, which are attached to the outer surface of the connecting part 150. The protrusion(s) 120 may be attached to the connecting part 150 by any suitable means, including, but not limited to, by welding or through one or more fastening devices such as bolts. The protrusion(s) 120 may comprise an angled surface 121. The angled surface 121 may be angled with respect to a longitudinal axis of the connecting part 150 (or elongate bar 110 or body). The angled surface 121 may be angled outwardly relative to a surface of the connecting part 150. The angled surface 121 may be configured to engage with a surface of the receiver 400 when in use. For example, the angled surface 121 may be configured to engage with a wall of a funnel 404 of the receiver 400.

The connector piece 200 may be positioned at an opposed end of the coupling device 100 to the connecting part 150. The connector piece 200 may be at the second end of the coupling device 100. The connector piece 200 may be attached to the connecting part 150. The connector piece 200 may be attached to the elongate bar 110 (or body). The connector piece 200 may be removably attached to the elongate bar 110. The connector piece 200 may be removably attached to the connecting part 150. The connector piece 200 may be removably attached to the second end of the coupling device 100.

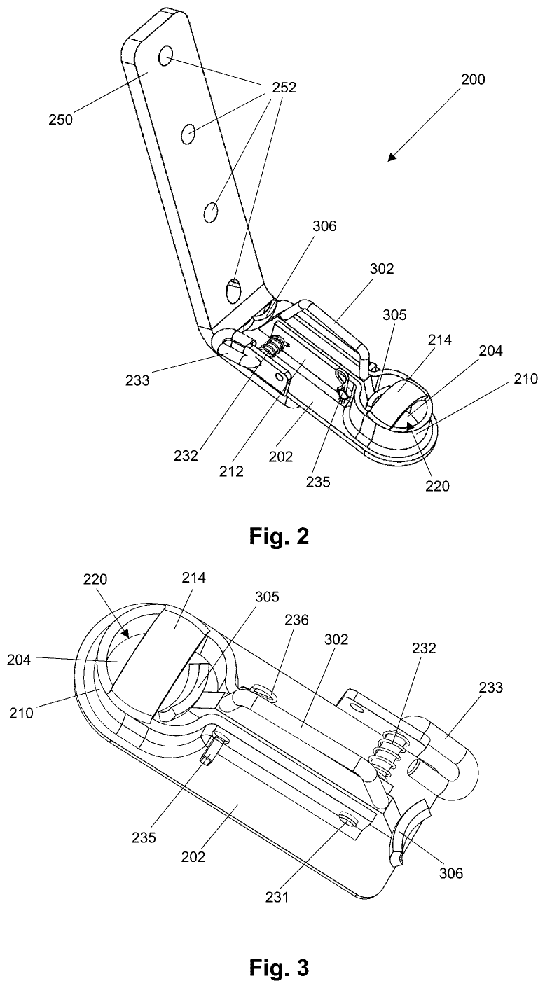

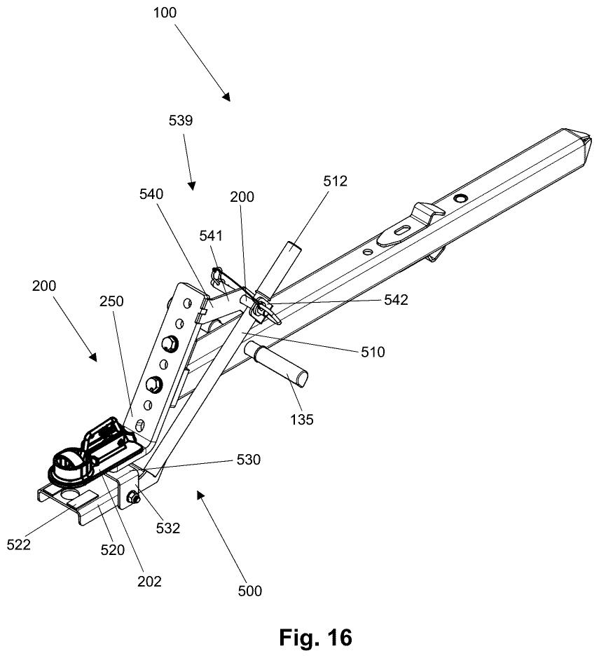

The connector piece 200 may be configured to be adjustable relative to the connecting part 150. The connector piece 200 may be configured to be height adjustable relative to the connecting part 150. The connector piece 200 may be configured to be height adjustable relative to the elongate bar 110 (or body). The connector piece 200 may be removably attachable to the connecting part 150 in a plurality of relative configurations. Each relative configuration may provide a different height of the connector piece 200 compared to the other relative configuration(s). In the embodiment shown in FIG. 1, the connector piece 200 comprises a plate 250. The plate 250 may include at least one aperture 252. The second end of the connecting part 150 may include a second end plate 114. The second end plate 114 may comprise at least one aperture 115. The plate 250 of the connector piece 200 may be removably fastenable to the second end plate 114. For example, the plate 250 of the connector piece 200 may be bolted to the second end plate 114, such as by bolts 260. The plate 250 of the connector piece 200 and second end plate 114 may be fastened and/or bolted together at a plurality of different height configurations. The bolts 260 may be passed through the apertures 115, 252 of each respective plate 114, 250 and secured as shown in FIG. 1. As shown in FIG. 5, the second end plate 114 comprises two apertures 115. In the example shown in FIG. 16, plate 250 includes seven apertures 252. As shown in FIG. 2, the plate 250 of the connector piece 200 comprises four apertures 252. The apertures 115 of the second end plate 114 may have the same spacing distance between them as the apertures 252 of the plate 250 of the connector piece 200. One of the plate 250 of the connector piece 200 and the second end plate 114 may comprise more apertures 115, 252 than the other. In the example shown, the connector piece 200 is positionable in one of three height configurations. Each of the three height configurations relates to which adjacent pair of apertures 252 of the plate 250 are bolted to the two apertures 115 of the second end plate 114. The connector piece 200 may be positionable at a plurality of different height configurations. The connector piece may be positionable at two, three, four, five, six, seven, eight, nine, ten or any desired number of height configurations. The number of height configurations may be determined by the number of apertures 115, 252 in each respective plate 114, 250.

The connector piece 200 may comprise a main portion 202. The main portion 202 of the connector piece 200 and the plate 250 may be attached to one another. The main portion 202 and the plate 250 may be integrally formed with one another. The main portion 202 and the plate 250 may be welded to one another or formed as a single piece. In possible configurations, the main portion 202 comprises the means for being removably attached to the connecting part 150. In other words, in possible configurations the connector piece 200 does not comprise the plate 250. The main portion 202 may comprise apertures to enable fastening and/or bolting to the second end plate 114. The main portion 202 of the connector piece 200 and at least one of the second end of a body of the coupling device 100, elongate bar 110 and/or the connecting part 150 may be removably attachable to one another. According to other configurations, the end piece and the second end of the connecting part 150 are removably attachable to one another through means other than fasteners or bolts.

According to possible embodiments, the connector piece 200 is integral with the second end of the elongate bar 110. According to possible embodiments, the connector piece 200 is integral with the second end of a body of the coupling device 100. According to possible embodiments, the connector piece 200 is integral with the second end of the connecting part 150.

The connector piece 200 may not be height adjustable relative to the connecting part 150. In some possible configurations, the connector piece 200 may be integral with or rigidly connected to the second end of the coupling device 100 and the coupling device 100 may comprise one or more parts adjustable to different heights. Towing vehicles of different types and sizes may have tow bars (or similar connection members) positioned at different heights compared to one another. Height adjustment of the connector piece 200 may result in the coupling device 100 being adaptable for use with towing vehicles having tow bars at varying heights.

According to some configurations, the connector piece 200 may be configured to removably attach to or receive a tow bar, hitch or tow ball of a predetermined size. The connector piece 200 may comprise a receiving area 220 for receiving a tow bar, hitch or tow ball. A receiving wall 210 of the connector piece 200 may define the receiving area 220. The receiving wall 210 may be connected to or integral with the main portion 202 of the connector piece 200. The receiving wall 210 may be positioned at one end of the main portion 202. The main portion 202 may define a void 204. The void 204 may pass entirely through the main portion 202, such as through a lower surface and through an upper surface of the main portion 202. The void 204 may be positioned relative to the receiving wall 210. The void 204 and receiving wall 210 may define the receiving area 220. In use, a tow bar, hitch or ball may be received in the receiving area 220 through the void 204. The connector piece 200 may comprise a cover or stop 214 over the void 204. The void 204 may have curved edges. The void 204 may be circular or substantially circular. The cover or stop 214 may limit the insertion distance of a tow bar, hitch or ball into the receiving area 220 to a desired amount. The cover or stop 214 may extend over and or between the receiving wall 210. In some configurations the connector piece 200 may comprise a plurality of receiving walls 210 which may together define the receiving area 220.

According to possible configurations, the connector piece 200 is adaptable for removably attaching to or receiving tow bars, hitches or tow balls of different sizes. The connector piece 200 may comprise means for altering the size of the receiving area 220. The receiving wall(s) 210 or a section of the receiving wall(s) 210 may be configured to move or be repositioned to adjust a size of the receiving area 220. The connector piece 200 may comprise an insert 300. The insert 300 may be at least partially received in, on or around the receiving area 220. The insert 300 may co-operate with the receiving wall(s) 210 to define the receiving area 220. A gap may exist in the receiving wall 210 or between adjacent receiving walls 210. The insert 300 may be positioned in the gap. The insert 300 may comprise at least one adapter 305, 306. The at least one adapter 305, 306 may, at least in part, define a size of the receiving area 220. The receiving area 220 may be circular or substantially circular in cross section.

An insert 300 according to one possible configuration is shown in FIG. 4. FIGS. 2 and 3 show the insert 300 positioned on the connector piece 200. In this example, the insert 300 comprises a first adapter 305 at one end and a second adapter 306 at an opposed end. Each adapter 305, 306 may comprise a curved surface. In the embodiment shown, the first adapter 305 and the second adapter 306 comprise a curved surface.

The insert 300 may be releasably connected to the main portion 202 of the connector piece 200. The insert 300 may connect to the main portion 202 in a single configuration. The insert 300 may connect to the main portion 202 in more than one configuration. In the example shown in FIGS. 2 and 3, the connector piece 200 comprises a channel which is configured, sized and/or shaped to receive the insert 300. The insert 300 may be received in the channel in a plurality of configurations. The insert 300 may be received in a first configuration where the first adapter 305, at least in part, defines the receiving area 220. The insert 300 may be received in a second configuration where the second adapter 306, at least in part, defines the receiving area 220. In the embodiment shown, a pair of channel walls 212 define the channel. The channel walls 212 may extend from the main portion 202 of the connector piece 200. The channel walls 212 may be integral with the main portion 202. The channel walls 212 may be welded to the main portion 202. The insert 300 may be received between the channel walls 212.

The insert 300 may be releasably connected to the main portion 202 and/or channel walls 212 of the connector piece 200. In the embodiment shown, the channel walls 212 and insert 300 each comprise through holes 308 which are aligned when the inserted is received by the channels. The through holes 308 may receive a pin to retain the insert 300 in position in the channel. One pin may comprise a spring 232 which biases the pin towards insertion through the through holes 308. The pin comprising the spring 232 may include a handle or loop 233 for a user to retract the pin from the through holes 308 when the insert 300 is to be removed. A second pin 235 may be provided which is manually inserted through aligned through holes 308. The second pin 235 may be retained in position by at least one retaining clip 236.

The insert 300 may comprise an insert handle 302, which may allow it to be easily removed, inserted or repositioned by a user. According to possible embodiments, a plurality of inserts may be provided. Each insert may include at least one adapter. According to possible embodiments, at least one adapter may be a part of the connector piece 200.

The coupling device 100 may comprise at least one second end handle 135. FIG. 1 shows two second end handles 135, but other configurations with a single handle and/or different configuration or shape of handle(s) are also possible. The at least one second end handle 135 may be positioned at the second end of the elongate bar 110 (or body). The second end handle 135 may be rigidly attached to the second end of the elongate bar 110. The second end handle 135 may be integral with or welded to the connecting part 150. The second end handle 135 may be used by a user to lift the second end of the elongate bar 110 to position the connector piece 200 in connection with a tow hitch, tow bar or tow ball of a towing vehicle. Lifting the second end handle 135 may allow a user to position a tow hitch, tow bar or tow ball of a towing vehicle within the receiving area 220 of the connector piece 200 to couple the coupling device 100 to the towing vehicle.

The coupling device 100 may comprise a stabiliser which is configured to retain the coupling device 100 in a desired position and/or orientation. For example, the stabiliser may be configured to hold the coupling device 100 in an alignment position prior to a releasable connection with the equipment. The connecting part 150 may comprise the stabiliser. The stabiliser may comprise at least one leg 140. The leg 140 may extend from a lower side of the connecting part 150 (or elongate bar 110). The leg 140 may be used to retain the coupling device 100 at a desired height above the ground. The leg 140 may be at least partly formed from a rigid material, such as a metal or metal alloy. The stabiliser may be integrally formed with the connecting part 150. The stabiliser may be coupled to the connecting part 150. The stabiliser may be welded to the connecting part 150. The stabiliser may include a foot 142. The foot 142 may be attached to a base of the leg 140. The foot 142 may engage the ground when the coupling device 100 is to be coupled to an equipment. The foot 142 may comprise a one or more materials, such as a metal or metal alloy. The foot 142 may be upwardly curved towards a first end of the coupling device 100 and/or towards a second end of the coupling device 100. The leg 140 extends transversely to the elongate bar 110. That is, an axial axis of the leg 140 extends transversely to the axis extending along the body forming the elongate bar 110. The leg 140 offsets the foot 142 from the elongate bar 110. In further embodiments, the leg 140 may form/providing a footing.

According to other possible embodiments, the leg 140 may comprise a jockey wheel. The jockey wheel may be height adjustable. The leg 140 may comprise or be replaced by a kickstand. The leg 140 and/or kickstand may be configured to be lifted up away from the ground when the coupling device 100 has been coupled to the equipment at the first end. The leg 140 and/or kickstand may be pivotally attached to the connecting part 150. The kickstand may comprise a foot to engage the ground in use.

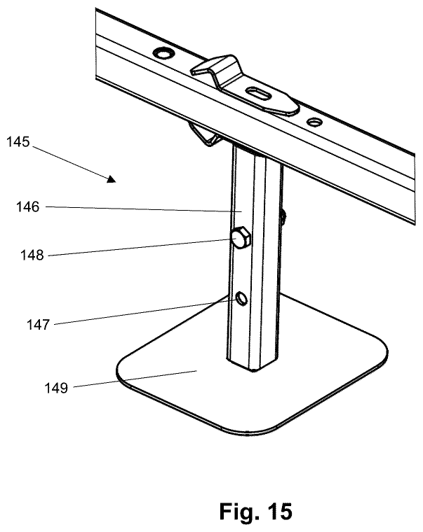

The leg 140 and/or kickstand may be height or length adjustable. An example of a height adjustable leg 145 for a coupling device is shown in FIG. 15. The leg 145 includes a ground engaging foot 149. In this example, the foot 149 includes a substantially flat base (or plate). In other arrangements, the foot 149 may be curved as in the example shown in FIG. 1. Similarly, the coupling device 100 of FIG. 1 may include a foot with a substantially flat base.

The height adjustable leg 145 includes a mechanism for adjusting the height of the coupling device 100. The mechanism provided in this example is a telescopic arrangement. Other possible embodiments may utilise different types of height adjustment mechanisms. The leg 145 comprises a hollow outer bar 146. An inner bar extends from the foot 149 which, in use, is received by and extends within the outer bar 146. The inner bar is obscured from view in FIG. 15 by the outer bar 146. The inner bar may be rigidly connected to the foot 149. The inner bar may be connected substantially at the centre of the foot 149.

To provide the telescopic height adjustment mechanism, the outer bar 146 slides relative to the inner bar. Attachment means may be provided for holding the outer bar 146 and inner bar in a respective height arrangement. In the example of FIG. 15, the outer bar 146 and inner bar are provided with through holes 147. A plurality of through holes 147 may be provided. The number of through holes in each of the outer bar 146 and inner bar being representative of the number of possible height configurations. For example, the arrangement shown in FIG. 15 includes two height configurations. The attachment means in this example is a bolt 148. The bolt passes through the through holes 147 in both the outer bar 146 and the inner bar. Other attachment means and/or fastener types may be utilised, such as a spring loaded fastener or locking pin.

The coupling device 100 may comprise at least one handle 130. The handle 130 may be positioned substantially centrally along a longitudinal direction of the coupling device 100. The embodiment shown in FIG. 1 comprises a pair of central handles 130. The handles 130 may be adjacent to one another but on opposed sides of the body forming the elongate bar 110. The handle(s) 130 may be utilised for carrying or manoeuvring the coupling device 100.

As described herein, the terms first end and second end have been used to refer to features as shown in the embodiments of a coupling device 100, and its components, in the accompanying figures. Other possible configurations are possible within the scope of the present disclosure. For example, the first end and second end may not be at opposed ends of the coupling device 100. It is understood that the positioning of the elements described as being in, on or at a first end may be otherwise positioned on the coupling device 100. Similarly, elements described as being in, on or at a second end may be otherwise positioned on the coupling device 100. According to other embodiments, the connector part 150 and connection piece 200 may not be located at opposed ends of the coupling device 100. For example, one of the connector part 150 and connection piece 200 could be located to a side laterally from the other, and/or could be positioned above or below the other, or positioned at any possible respective location direction from the other.

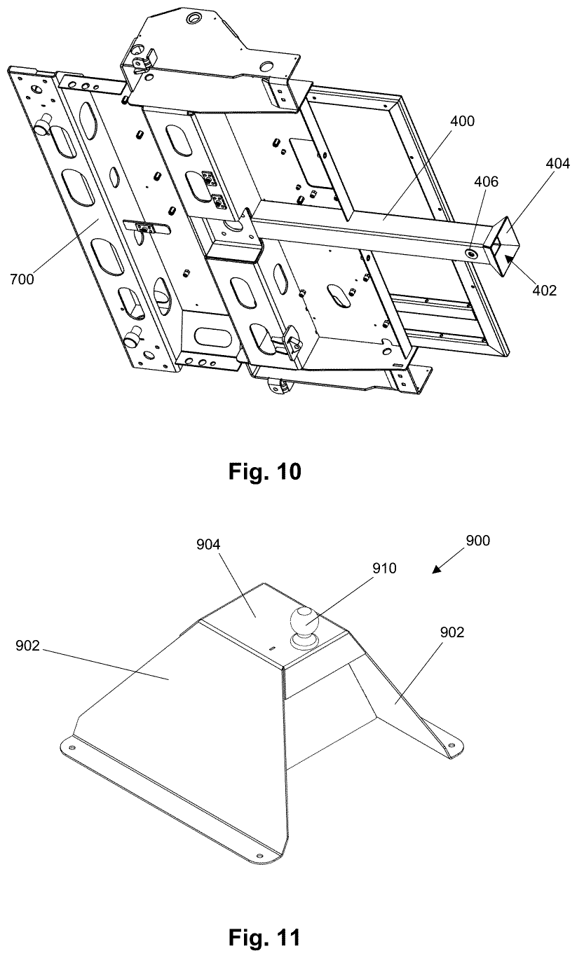

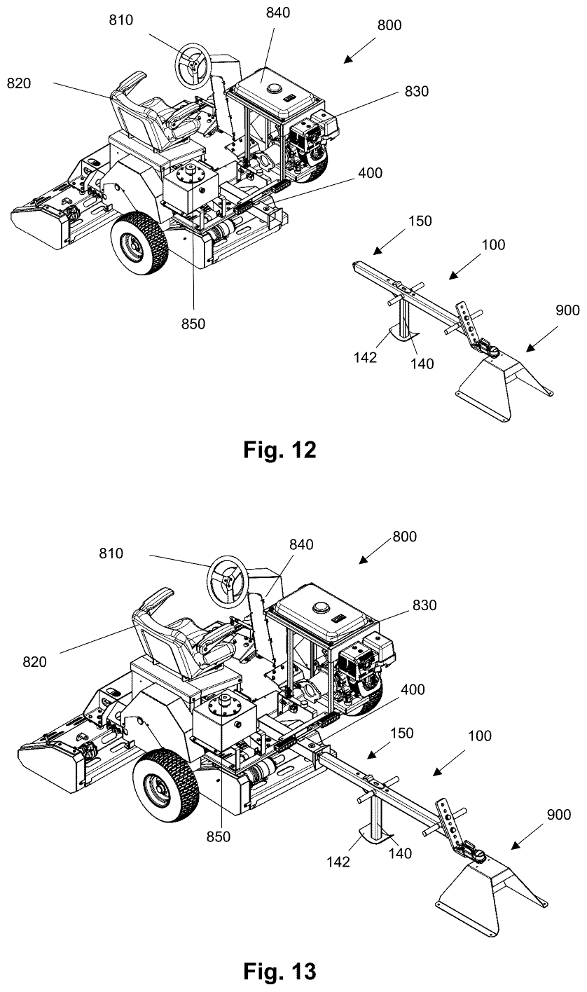

FIGS. 6 to 9 depict part of a turf roller 600 according to a possible embodiment of the present disclosure. The part of the turf roller 600 comprises a frame 700. An example of a frame 700 is shown in FIG. 10. The frame 700 may comprise a bed or deck on which components of the turf roller 800 may be mounted. For example, FIGS. 12 to 14 show a turf roller 800 comprising a number of components not shown on the part in FIGS. 6 to 9. Any description herein relating to part of the turf roller 600, for example shown in FIGS. 6 to 9, is equally applicable to a turf roller as a whole or any equipment that is configured to be coupled to the coupling device 100.

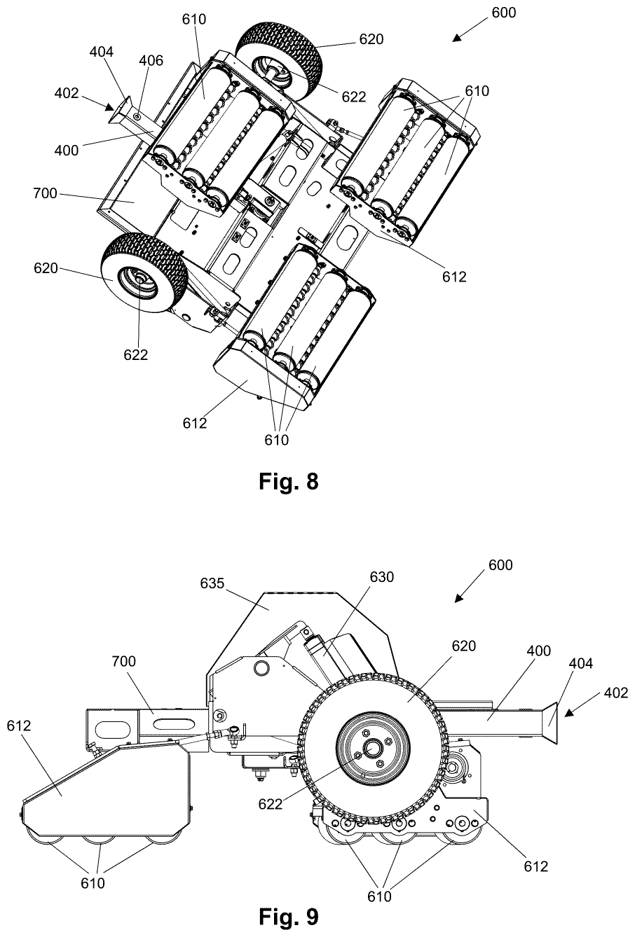

Rollers 610 may be attached to the underside of the frame 700. The rollers 610 may be housed with one or more roller housing 612. The rollers 610 may each be rotationally mounted on a respective axle. In the example of FIG. 8, the part of the turf roller 600 comprises three roller housings 612 and each roller housing 612 houses three rollers 610. The rollers 610 may be each aligned in substantially the same direction or plane when in use on a turf roller 800 moving in a straight line. The rollers 610 are mounted such that they typically all engage the ground when in use on a flat ground surface. At least one roller 610 may be pivotally mounted to the frame 700 such that its orientation may be changed. The orientation of the at least one pivotally mounted roller 610 may be controlled by a user. Control of the orientation of the at least one pivotally mounted roller 610 may be through a controller, such as a steering wheel 810, control stick or joystick or other input device. The change in orientation may be used to steer the turf roller 800 when in use. At least one roller housing 612 may be pivotally mounted to the frame 700 in a similar manner as described in relation to at least one roller 610, such that the orientation of each roller 610 within that roller housing 612 may be altered together.

The turf roller 800 may include at least one wheel 620. In the examples shown in the accompanying figures, the turf roller includes a pair of wheels 620. Other examples are possible where the turf roller 800 includes one, three, four or more wheels 620. The wheels 620 may be each mounted on a respective axle 622. In other embodiments, a single axle may be used to mount two wheels 620. The turf roller may include at least one mechanism 630 for raising and lowering the wheel(s). In the embodiments shown, each wheel 620 has a respective raising/lowering mechanism 630. The or each mechanism 630 may comprise at least one actuator. The mechanism 630 may be powered by a motor, such as a mechanical or electric motor. The part of the turf roller 600 may comprise a mechanism cover 635 which hides a mechanism 630 for raising/lowering the wheel(s).

The wheels 620 are in a raised orientation in the embodiment shown in FIGS. 6 to 9, as particularly seen in the side view of FIG. 9. When the wheels 620 are in the raised orientation, the rollers 610 will be in engagement with the ground and the turf roller 600 may be used to roll, smooth or flatten the ground. When the wheels 620 are in a lowered position, the rollers 610 will become raised above the ground and the wheels 620 will engage the ground. With the wheels 620 in the lowered position, the turf roller/equipment may be towed.

The equipment may comprise an attachment portion. The attachment portion may be configured to connect to the coupling device 100. The attachment portion may comprise a receiver 400, as shown on the part of the turf roller 600 in FIGS. 6 to 9 and on the frame 700 shown in FIG. 10. The receiver 400 may comprise an elongate tube of material. The receiver 400 may be formed from a metal or metal alloy. The receiver 400 may have a substantially rectangular or square cross-section. The cross-sectional shape of the receiver 400 may substantially match a cross-sectional shape of the connecting part 150 of the coupling device 100. The receiver 400 may be hollow and may comprise an inner conduit. The inner conduit may be sized and/or shaped such that the connecting part 150 may be received therein. For example, an outer cross-sectional area of the connecting part 150 may be substantially the same as or slightly smaller than the inner cross-sectional area of the inner conduit of the receiver 400. The conduit may have substantially the same cross-sectional shape and/or area along its length. A length of the conduit and/or receiver may be at least as long as a length of the connecting part 150 between the at least one protrusion 120 and the termination of the connecting part 150 (or tip of the spike 112, where present).

The receiver 400 may comprise an opening 402 into which the termination of the connecting part 150 may be inserted. The receiver 400 may comprise a funnel 404 at its opening 402. The funnel 404 may comprise a tapered collar. The cross-sectional shape of the funnel 404 may be rectangular or square. The cross-sectional area of the funnel 404 may be substantially largest at its opening 402 and may taper down towards the conduit.

The receiver 400 may be mounted to any respective equipment to be towed. As shown in FIGS. 6 to 10, the receiver 400 is mounted to the frame 700 of the turf roller 800. The frame 700 shown and described in relation to FIG. 10 could be replaced with a frame 700 of a desired equipment to be towed and may not be limited to a frame 700 of the turf roller 800. The receiver 400 may be mounted to the frame 700 such that it is substantially parallel to the ground. The receiver 400 may be rigidly mounted to the frame 700. The receiver 400 may be integral with the frame 700. The receiver 400 may be welded to the frame 700. The receiver 400 may be a separate element attachable to a frame 700 of an existing equipment.

According to possible embodiments, the coupling device 100 and the equipment may be releasably locked together when the connecting part 150 has been inserted into the receiver 400 by a predetermined amount. The coupling device 100 and equipment may comprise respective couplings that can be locked together. The couplings may be on the connecting part 150 and the receiver 400. Alternatively, the couplings that lock together may be provided elsewhere on the coupling device 100 and the equipment. For example it is contemplated that the connecting part 150 could be inserted a predetermined distance into the receiver 400 and then a different part of the coupling device 100 could interlock with a corresponding part of the equipment.

The receiver 400 and coupling device 100 may be releasably locked into coupling with one another when positioned in a desired relative relationship. For example, they may be releasably locked in coupling via at least one pin, bolt or other fastener. The locking between the receiver 400 and the coupling device 100 may be automatically initiated when the two are brought into a relative alignment with one another. Alternatively, they may be releasably locked together manually by a user.

The receiver 400 may comprise at least one hole 406. The coupling device 100 may comprise at least one hole 152. The connecting part 150 may comprise the at least one hole 152 of the coupling device 100. The at least one hole 152 of the coupling device 100 may be substantially the same diameter as the at least one hole 406 of the receiver 400. The hole 406 of the receiver 400 may be in alignment with the hole 152 of the coupling device 100 when the connecting part 150 is inserted a predetermined amount into the receiver 400. In the embodiment shown in the Figures, the receiver 400 comprises two holes 406 in opposed sides of the receiver 400 and the connecting part 150 comprises two holes 152 in opposed sides of the connecting part 150. A coupling pin 160 may be inserted through each of the pairs of holes when the connecting part 150 and receiver 400 are in correct alignment, which may lock the two in their relative positions. The coupling pin 160 may comprise a locking clip on one side to lock it in position in the holes. The coupling pin 160 may comprise a handle or loop.

According to other embodiments, a locking pin may comprise a biasing member which automatically engages the locking pin with at least one hole in one or both of the receiver 400 and coupling device 100 when the receiver 400 and coupling device 100 are in an alignment position. The biasing member may be a spring. One of the receiver 400 and the coupling device 100 may comprise the locking pin. The locking pin may be in a retracted position when the connecting part 150 is inserted in the receiver 400, and the coupling device 100 and receiver 400 are not in a locking alignment position. Moving the receiver 400 and coupling device 100 relative to one another to an alignment position may cause the locking pin to engage and lock the receiver 400 and coupling device 100 together. The locking pin may take a variety of forms including a locking ball.

The at least one protrusion 120 of the coupling device 100 may engage with at least one surface of the receiver 400 when the coupling device 100 and receiver 400 are in a locking alignment position. The at least one protrusion 120 and at least one surface may prevent the connecting part 150 from being inserted into the receiver 400 beyond the locking alignment position. The at least one surface of the receiver 400 which engages the at least one protrusion 120 may be at the opening 402 of the receiver 400. The funnel 404 may comprise the at least one surface that engages with the at least one protrusion 120. The funnel 404 may comprise at least one surface that is angled in substantially the same plane as the angled surface 121 of the at least one protrusion 120, at least when they engage one another.

FIG. 11 shows a connector stand 900. The connector stand 900 may be utilised in place of a towing vehicle to connect to the connector piece 200 of the coupling device 100. For example, the connector stand 900 may be positioned in a storage location for coupling to the coupling device 100, which is coupled to an equipment, such as a turf roller 800, when the equipment is not in use. Additionally or alternatively, the connector stand 900 may be coupled to the connector piece 200 of the coupling device 100 and used to hold the coupling device 100 in a desired orientation/position before or during a coupling process with the equipment.

In practice, the connector stand 900 is a mount for a tow hitch, tow bar or tow ball 910. The connector stand 900 may hold the tow hitch, tow bar or tow ball 910 in a desired position, height and/or orientation. The connector stand 900 may comprise a box structure or saddle structure. The connector stand 900 may comprise at least one side wall 902. The embodiment shown in FIG. 11 comprises two side walls 902. The connector stand 900 may comprise an upper wall 904. The upper wall 904 may be distanced from the ground by a predetermined distance. The connector stand 900 may comprise at least one of a tow bar, a tow hitch and a tow ball 910, which may be located on or adjacent to the upper wall 904. In the embodiment shown in FIG. 11, the connector stand 900 comprises a tow ball 910. The embodiments in FIGS. 12 to 14 show the connector piece 200 of the coupling device 100 coupled to the tow ball 910 of the connector stand 900.

The embodiments in FIGS. 12 to 14 show a coupling device 100, connector stand 900 and turf roller 800 (which comprises the part of the turf roller 600), these elements include features as described and shown in relation to the FIGS. 1 to 11. FIGS. 12 to 14 also show features of a turf roller 800 not provided on the part of the turf roller 600 shown in FIGS. 6 to 9. These features of a turf roller 800 include a seat 820, a steering wheel 810, an actuator button 850, a motor 830, and a fuel tank 840.

FIG. 6 depicts the part of the turf roller 600 coupled to the coupling device 100. The part of the turf roller 600 and coupling device 100 are locked into coupling with one another through the coupling pin 160 engaging through the receiver 400 and connecting part 150, such as in a similar manner as described above.

FIGS. 12 to 14 show a docking procedure between the coupling device 100 and equipment, which is a turf roller 800 in these Figures. FIG. 12 shows an orientation where the coupling device 100 and the turf roller 800 spaced apart from one another. In this orientation, the foot 142 of the leg 140 of the coupling device 100 is engaging the ground to hold the coupling device 100 in the orientation. The turf roller 800 may be, if not already, moved or steered such that the receiver 400 of the turf roller 800 and termination of the connecting part 150 are substantially in alignment with one another. The turf roller 800 may then be moved or driven towards the coupling device 100. Preferably, the turf roller 800 is driven towards the coupling device 100 on its rollers and when its wheels 620 are in a raised orientation away from the ground. The turf roller 800 may be driven towards the coupling device 100 in a forwards direction. The turf roller 800 may be driven towards the coupling device 100 in a backwards direction or, in other words, reversed towards the coupling device 100. The opening 402 of the receiver 400 may be located at a rear of the turf roller 800. The opening 402 of the receiver 400 may be located at a front of the turf roller 800. The front and/or rear of the turf roller 800 facing in a direction in which the turf roller 800 may be driven on its rollers 610.

FIG. 13 shows an orientation where the turf roller 800 has been moved toward the coupling device 100 such that the termination of the connecting part 150 is within the opening 402 of the receiver 400. The termination of the connecting part 150, and spike 112 where present, may engage with the funnel 404 to locate the termination of the connecting part 150 within the opening 402. This may correct for any slight misalignments between the receiver 400 and connecting part 150 when the turf roller 800 is driven towards the coupling device 100.

FIG. 14 shows a locked orientation where the turf roller 800 and coupling device 100 have been brought fully into alignment with one another. The connecting part 150 of the coupling device 100 is inserted the predetermined distance into the receiver 400 in this orientation. The protrusions 120 of the coupling device 100 are engaged with surfaces of the funnel 404 at the opening 402 of the receiver 400. As also shown in FIG. 14, the coupling pin 160 has been inserted to lock the turf roller 800 and coupling device 100 into coupling together. When the turf roller 800 is to be removed from the coupling device 100 (or vice versa), the coupling pin 160 may be removed and the turf roller 800 may be driven away from the coupling device 100 until they are again in the first orientation shown in FIG. 12, for example.

When the turf roller 800 and coupling device 100 are in the locked orientation, similarly as shown in FIG. 14, the wheels 620 of the turf roller 800 may be moved into the lowered orientation. The turf roller 800 may comprise a control which controls the raising and lowering of the wheels 620. The control may be operated by the user to lower the wheel. Lowering the wheels 620 of the turf roller 800 may cause the foot 142 and leg 140 of the coupling device 100 to be lifted above the ground, such that the leg 140 or foot 142 does not hinder towing of the turf roller 800.

The coupling of the coupling device 100 to the towing vehicle is not shown in the Figures. The coupling between the coupling device 100 and the towing vehicle may be substantially similar to the coupling between the coupling device 100 and the connector stand 900 as shown in FIGS. 12 to 14. The height of the connector piece 200 may be adjusted prior to coupling with a tow hitch, tow bar or tow ball of the towing vehicle. When the connector piece 200 is at the desired height the towing vehicle may be reversed towards the second end of the coupling device 100. The second end handles 135 may be used to lift the second end of the coupling device 100 and to cause the connector piece 200 to engage with a tow hitch, tow bar or tow ball of the towing vehicle. The connector piece 200 in the embodiment shown in the Figures is configured to connect to a tow ball on a towing vehicle.

According to other possible embodiments, the coupling between the coupling device 100 and the towing vehicle may be through some means other than a connector piece 200 and a tow hitch, tow bar or tow ball. For example, there may be a hook arrangement to hook the second end of the coupling device 100 to the towing vehicle.

The coupling device 100 may be configured to be coupled at the first end to the equipment, such as a turf roller 800, and at the second end to the towing device in any order. For example, the coupling device 100 may be first connected at its second end to the towing vehicle. The coupling device 100 may then then be connected to the equipment by moving the equipment to cause engagement between the receiver 400 and the connecting part 150 and then locked in position. Alternatively, the coupling device 100 may be connected to the equipment first and the second end of the coupling device 100 may be connected to the towing vehicle thereafter.

A further example of a coupling device 100 is shown in FIGS. 16-19. This example of a coupling device 100 includes a stabiliser in the form of a clamping mechanism 500. The clamping mechanism 500 may be used in place of or in addition to a leg. The clamping mechanism 500 may be configured to clamp onto a tow bar of a towing vehicle such that the coupling device 100 may be held in a suitable orientation to attach to an equipment, such as a turf roller. This arrangement may avoid the need for a kickstand, leg, e.g. leg 140, 145, and/or jockey wheel. The clamping mechanism 500 may attach the coupling device 100 to a towing vehicle in preparation for connection to equipment, such as a turf roller.

In the example shown in FIGS. 16-19, the coupling device 100 shares various features with the coupling devices as previous described in other examples. The example in FIGS. 16-19 does not include a leg/kick stand or handle 130 positioned substantially centrally along a longitudinal direction of the coupling device. The coupling device in FIGS. 16-19 includes only one set of handles 135 near the second end of the elongate bar 110.

It would be appreciated that any of the features shown in or described in relation to the examples of FIGS. 16-19 may be combined with or replace features of any other examples or embodiment shown or described herein. For example, within the present disclosure any of the features of a coupling device shown in FIGS. 16-19 may be combined with any features of the coupling device shown in FIG. 1.

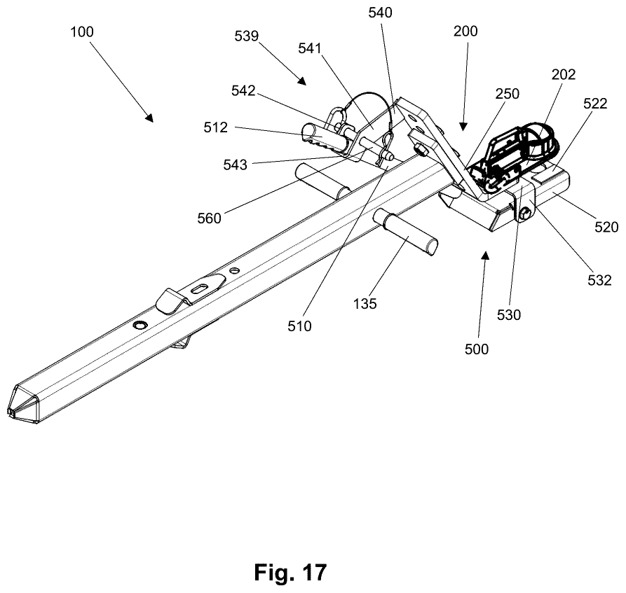

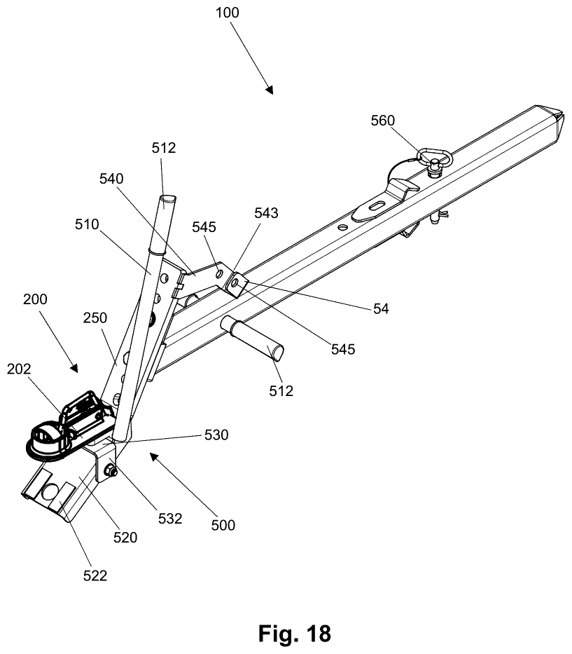

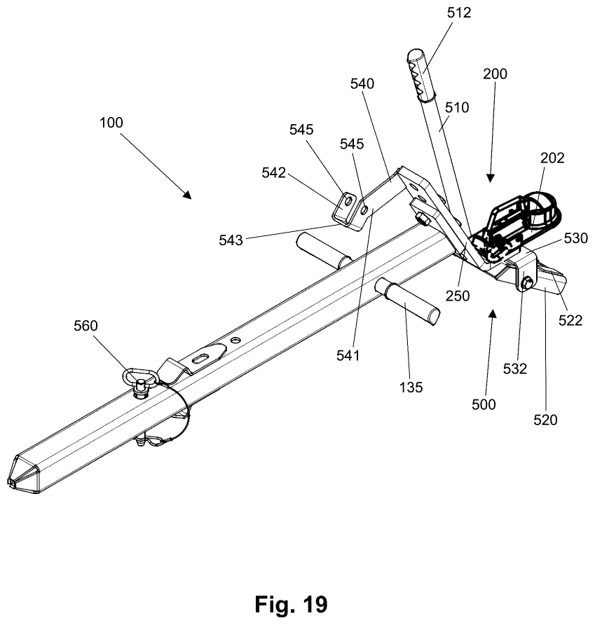

As indicated above, the coupling device 100 may include clamping mechanism 500 of FIGS. 16-19, which may act as a stabiliser. The clamping mechanism 500 may include a pivoting element. The pivoting element may include at least part of a jaw 520. The jaw 520 may be attached to a lever 510. That is, the lever 510 is attached at one end to the jaw 520. The lever 510 may include a hand grip 512 at an end distal to the jaw 520. The pivoting element is configured to pivot relative to the connector piece 200. In use, the lever 510 may be pushed/pulled to cause the jaw 520 to move between a first and second orientation. For example, the jaw 520 may move between clamped and unclamped orientations (with, eg, a towbar). FIGS. 16 and 17 show the clamping mechanism 500 in a clamped orientation and FIGS. 18 and 19 show the clamping mechanism 500 in an unclamped orientation.

A pivot part 530 may be connected or attached to the connector piece 200 or provided elsewhere on the coupling 100. The pivot part 530 may form a pivot plate. In the example shown, the pivot part 530 is connected to an underside of the main portion 202 or plate 250 of the connector piece 200. The pivoting element may be pivotally connected to the pivot part 530, and/or the pivoting element may pivot about the pivot part 530. The pivot part 530 may include a pair of arms 532 that extend downwardly from either side of the main portion 202. The arms 532 and jaw 520 may include apertures on each side. A shaft may extend through the apertures in the arms 532 and jaw 520. The shaft may be affixed in place, for example, not limited to, via a threaded connection to the arms 532. The jaw 520 may be pivotally connected to the shaft. The pivot part arms 532 may be pivotally connected to the shaft or may be substantially rigidly connected thereto. The jaw 520 may pivot on the shaft when the lever 510 is actuated (pushed/pulled). In this regard, the lever 510 rotates in order to move the jaw 520. According to alternative embodiments, the pivoting element may be configured such that the lever 510 pivots about a part of the connector piece 200. In further embodiment, the jaw 520 may translate in a linear direction to clamp onto part of, for example, a tow bar.

The jaw 520 may include at least one pad. The at least one pad may be a grip pad 522. The grip pad(s) 522 may be manufactured from a material configured to increase friction with a tow bar when the clamping mechanism 500 is in a clamped orientation. The grip pad(s) 522 may be formed from an elastic, plastic, flexible and/or resilient material. For example, the grip pad(s) may be formed from at least one of rubber, silicon, a polymeric material, an elastomer or similar material. Alternatively, the jaw 520 may include a plurality of teeth (not shown) configured to engage with a tow bar when the clamping mechanism 500 is in a clamped configuration. The grip pad(s) 522 may be configured to avoid metal on metal engagement when the clamping mechanism 500 clamps with a tow bar. The at least one pad may be alternated and provide different compliance between the jaw 520 and the connector piece 200 in order to adjust the force a user may require to rotate the lever 510 and clamp the jaw 520.

The coupling device 100 includes a retaining mechanism 539. The retaining mechanism 539 is configured to retain the clamping mechanism 500 in a clamped orientation. The retaining mechanism 539 includes a retaining portion. In the example of FIGS. 16-19, the retaining portion includes a retaining plate 540. The retaining plate is connected to the plate 250. The retaining portion may include a first side 541 and a second side 542 which are connected by back 543. The first side 541 and second side 542 each include a hole 545. The holes 545 of the first side 541 and second side 542 being in alignment with one another such that a pin 560 may be passed through them. The back 543 and sides 541, 542 are positioned such that the lever 510 may rest against the back 543 between the sides 541, 542 when the clamping mechanism 500 is in a clamped orientation, as shown in FIGS. 16 and 18. The pin 560 may be pass through the holes 545 in the first and second sides 541, 542 to retain the lever 510 and thereby retain the clamping mechanism 500 in the clamped position.

Alternative means may be provided to retain the clamping mechanism 500 in the clamped orientation. For example, according to one possible alternative, the lever may include a hole, or may be attached to a retaining portion having a hole. In that alterative example, the pin could be passed through the hole in the lever and hole in the retaining portion in order to retain the clamping mechanism 500 in the clamped orientation. Numerous other retaining means could be provided within the scope of the present specification, as would be understood by a person skilled in the art.

It is also envisaged that, in other examples, the clamping mechanism 500 could be retained in more than one clamped position. This may enable the clamping mechanism to clamp onto tow bars of varying size (height, depth or width). Alternatively, the clamping mechanism could be resiliently retained in a clamped orientation when clamped onto a tow bar, whereby the resilient nature of retention may account for differences in size of the two bar.

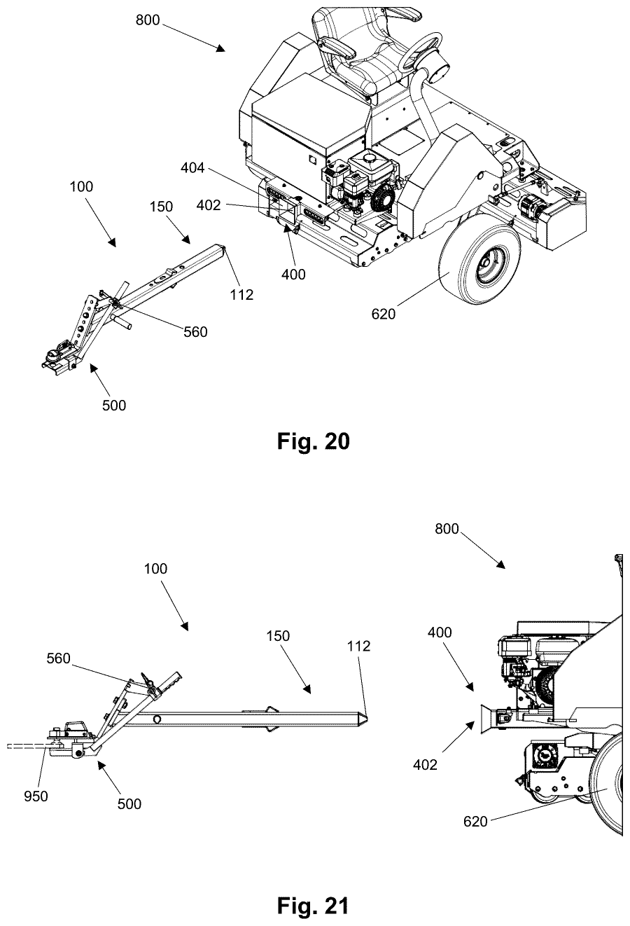

FIGS. 20 to 23 show a docking procedure between the coupling device 100, including clamping mechanism 500, and equipment, which is a turf roller 800 in these Figures. FIGS. 20 and 21 show an orientation where the coupling device 100 is clamped to a tow bar 950 (shown in dashed lines in FIG. 21) of a towing vehicle. The turf roller 800 being spaced apart from the coupling device 100. Through being clamped to the tow bar 950, the coupling device 100 is retained thereon in a substantially horizontal alignment. The clamping mechanism 500 is retained in the clamped orientation by the pin 560 being retained in the holes 545 of retaining plate 540 such that the lever 510 is held in place (as shown in FIGS. 16 and 18).

The turf roller 800 may be, if not already, moved or steered such that the receiver 400 of the turf roller 800 and termination of the connecting part 150 are substantially in alignment with one another. This alignment is shown in FIGS. 20 and 21. The turf roller 800 may then be moved or driven towards the coupling device 100. That is, the turf roller 800 may be driven towards the coupling device 100 on its rollers and when its wheels 620 are in a raised orientation away from the ground. Alternatively, the vehicle may be driven towards the turf roller 800 to engage the coupling device 100 with the turf roller.

In either scenario above, the connecting part 150 is received by the opening 402 of the receiver 400. A spike 112 on the connecting part 150 may engaged with a funnel or tapered surface to correct for misalignments between the receiver 400 and connecting part 150 when they are moving relative to one another.

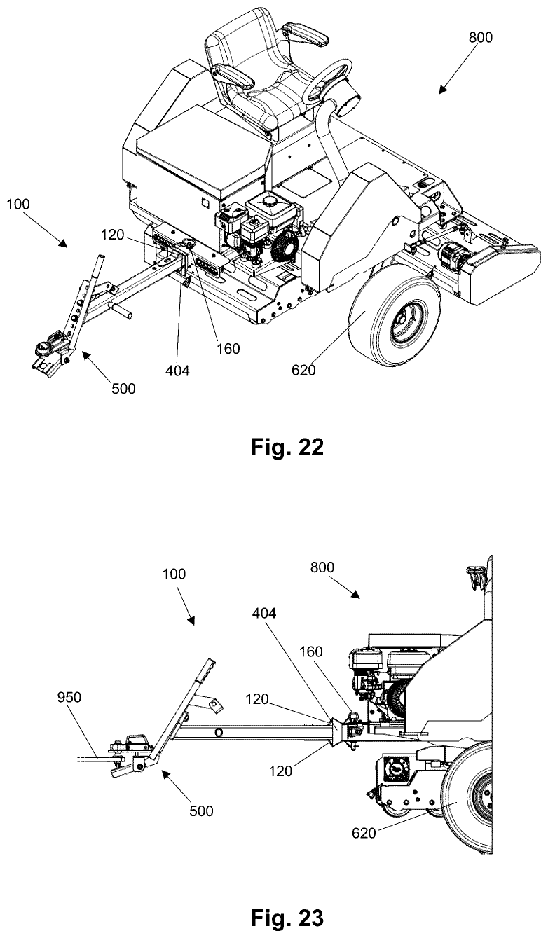

The turf roller 800 and/or vehicle will continue moving until the connecting part 150 reaches a final position with the receiver 400. The final position is shown in FIGS. 22 and 23. In the final position, connecting part 150 of the coupling device 100 is inserted a predetermined distance into the receiver 400 and the turf roller 800 and coupling device 100 are fully in alignment with one another. At least one protrusion 120 on the coupling device 100 may engage with surfaces of the funnel 404 at the opening of the receiver 400 in the final position. A coupling pin 160 is inserted into apertures in the receiver 400 and coupling device 100 to retain and lock the coupling device 100 and turf roller 800 into coupling together. The coupling pin 160 may be the same as pin 460 which retains the lever 510 in the clamped orientation. They may be the same pin 460 because preferably the clamping mechanism 500 of the coupling device 100 is the unclamped orientation when a towing vehicle tows the equipment (turf roller 800). Unclamping the clamping mechanism 500 may allow the coupling device 100 to pivot about the tow ball, rather than be rigidly connected to one another. In the examples shown in FIGS. 22 and 23, the clamping mechanism 500 is in the unclamped orientation and unclamped from the tow bar 950. The clamping mechanism 500 may be held in the unclamped position with a releasable attachment.

As with other embodiments herein, when the turf roller 800 and coupling device 100 are locked together, such as shown in FIGS. 22 and 23, the wheels 620 of the turf roller 800 may be moved into the lowered orientation. A towing vehicle may then tow the equipment effectively.

As described herein, a coupling device 100 comprises a connecting part 150 that is configured for insertion at a first end into a receiver 400 on an equipment. It is envisaged that the receiver 400 and connecting part 150 could be switched between the coupling device 100 and the equipment. In other words, according to possible embodiments the coupling device 100 may comprise a receiver 400 and the equipment may comprise a connecting part 150 configured for insertion into the receiver 400. In those embodiments, other features may be switched between the equipment and coupling device 100 as may be necessary. For example, a connecting part 150 on the equipment may comprise at least one protrusion 120 to engage with an opening 402 of the receiver 400 on the coupling device 100. Some features may be retained on the respective equipment or coupling device 100 according to these possible embodiments. For example, the coupling device 100 may comprise a leg which may extend from a lower surface of the receiver 400 and/or may comprise a clamping mechanism 500. The embodiments where the equipment comprises a connecting part 150 may be slightly less desirable than where the equipment comprises a receiver 400 as the connecting part 150 may extend a distance from the equipment which may create a potential hazard when the equipment, such as a turf roller 800, is in use and/or it may provide an visual obstruction to a user of the equipment. However, these embodiments may still be advantageous over conventional equipment, as are the other embodiments described herein, for enabling a suitable coupling between an equipment and a coupling device 100, and ultimately to a tow vehicle, to be performed. A person skilled in the art will understand which features may be switched between the coupling device 100 and equipment and those features and amendments are within the scope of the present disclosure.

The above description references a turf roller or part of a turf roller. It is noted that the present disclosure may extend to a coupling device 100 that couples any piece of equipment, not limited to turf rollers, to a towing vehicle or to a connector stand.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

### LIST OF DRAWING REFERENCES

100 Coupling device
110 Elongate bar
112 Spike
114 Second end plate
115 Aperture
120 Protrusion
121 Angled surface
130 Handle
135 Second end handle
140 Leg
142 Foot
145 Height adjustable leg
146 Outer bar
147 Through hole
148 Bolt
149 Foot
150 Connecting part
152 Hole
160 Coupling pin
200 Connector piece
202 Main portion
204 Void
210 Receiving wall
212 Channel wall
214 Cover/stop
220 Receiving area
231 Pin
232 Spring
233 Loop
235 Second pin
236 Retaining clip
250 Plate
252 Aperture
260 Bolt
300 Insert
302 Insert handle
305 First adapter
306 Second adapter
308 through hole
400 Receiver
402 Opening
404 Funnel
406 Hole
500 Clamping mechanism
510 Lever
512 Hand grip
520 Jaw
522 Grip pad
530 Pivot part
532 Arm
539 Retaining mechanism
540 Retaining plate
541 First side
542 Second side
543 Back
545 Hole
560 Pin
600 Part of a turf roller
610 Roller
612 Roller housing
620 Wheel
622 Axle
630 Mechanism
635 Mechanism cover
700 Frame
800 Turf roller
810 Steering wheel
820 Seat
830 Motor
840 Fuel tank
850 Actuator button
900 Connector stand
902 Side wall
904 Upper wall
910 Tow ball
950 Tow bar

1. A coupling device configured to connect an equipment to a towing vehicle, wherein the coupling device comprises:
a connecting part configured to releasably connect to the equipment;
a stabiliser configured to assist in holding the coupling device in an alignment position prior to releasable connection with the equipment; and
a connector piece configured to releasably connect to a corresponding connector on the towing vehicle.

2. The coupling device of claim 1, wherein the equipment is a turf roller or a ride-on turf roller.

3. The coupling device of claim 1, wherein the stabiliser comprises a clamping mechanism configured to releasably clamp the coupling device to a tow bar of the towing vehicle.

4. The coupling device of claim 3, wherein the clamping mechanism comprises a lever and a jaw, the lever being actuatable by a user, and the jaw being configured to perform a clamping action on the tow bar.

5. The coupling device of claim 1, wherein one of the connecting part and an attachment portion of the equipment comprises a receiver and the other comprises an engaging member, and wherein a termination of the engaging member includes at least one wall tapering towards a central axis of the engaging member.

6. The coupling device of claim 1, wherein the connecting part comprises an engaging member having at least one protrusion configured to engage with a surface of the equipment when the connecting part is in a locking position.

7. The coupling of claim 6, wherein the at least one protrusion includes an angled surface to a vertical plane.

8. The coupling device of claim 1, wherein the connector piece is a coupler configured to receive a tow bar, tow hitch or tow ball, and wherein the coupler includes a size adjustable portion such that it may receive different tow bar, tow hitch or tow ball sizes, and wherein the size adjustable portion includes at least one insert.

9. The coupling device of claim 1, further comprising an adjustment structure such that a position of the connector piece on the connecting part can be adjusted to suit towing vehicles having the corresponding connector at different heights above the ground, and wherein the adjustment structure comprises a pair of plates which are fastenable to each other in a plurality of relative positions.

10. An equipment comprising a turf roller configured to connect to the connecting part of the coupling device of claim 1.

11. The equipment of claim 10 comprising a receiver with an opening to receive an engaging member of the connecting part of the coupling device, and wherein the receiver comprises an opening and a tapered funnel at the opening.

12. The equipment of claim 10, wherein the turf roller comprises:
at least a pair of wheels; and
at least one mechanism for moving the wheels towards or away from the ground.

13. A method of coupling an equipment to a towing vehicle, wherein the method comprises:
a) providing a coupling device according to claim 1, the coupling device having a connecting part and a connector piece;
b) providing an equipment;
c) providing a towing vehicle having a corresponding connector;
d) connecting the connecting part of the coupling device to the equipment and releasably locking the coupling device to the equipment; and
e) coupling the connector piece of the coupling device to the corresponding connector of the towing vehicle.

14. The method of claim 13, wherein step e) includes utilising a clamping mechanism of the coupling device to clamp the coupling device to a towing bar of the towing vehicle.

15. A method for coupling an equipment to a coupling device, the method comprising:
providing a coupling device, the coupling device having a connecting part;
positioning the coupling device such that the connecting part is at a first height above a ground;
providing an equipment, the equipment having an attachment portion, wherein the attachment portion and connecting part are configured to engage with one another; and
engaging the attachment portion with the connecting part.

16. The method of claim 15, wherein the equipment is a turf roller comprising a plurality of rollers and moving the equipment towards the connecting part comprises driving the turf roller on its rollers.

17. The method of claim 15, wherein the coupling device comprises a stabiliser which positions the connecting part at the first height such that the connecting part and attachment portion are substantially in alignment prior to and during engagement of the connecting part with the attachment portion.

18. The method of claim 17, wherein the coupling device comprises a connector piece and the method further comprises coupling the connector piece to a towing vehicle, and wherein the stabiliser comprises a clamping mechanism which clamps the coupling device to a tow bar of the towing vehicle to hold the connecting part at the first height above the ground.

19. The method of claim 17, wherein the stabiliser comprises a leg sized to hold the connecting part at the first height above the ground.

20. The method of claim 15. wherein the equipment comprises at least one wheel, and the wheel is moved to a lowered position, where it engages the ground, after the attachment portion and the connecting part are engaged with one another in order to tow the equipment.
